(19) United States
(12) Patent Application Publication
(10) Pub. No.: US 2026/0329620 A1
(43) Pub. Date: Oct. 22, 2026

(54) APPARATUS AND METHOD FOR PROCESSING RADAR SIGNAL

(71) Applicant: HL KLEMOVE CORPORATION, Incheon (KR)

(72) Inventor: Beom-Jun SON, Incheon (KR)

(73) Assignee: HL KLEMOVE CORPORATION, Incheon (KR)

(21) Appl. No.: 19/541,834

(22) Filed: Feb. 17, 2026

(30) Foreign Application Priority Data
Apr. 18, 2025 (KR) 10-2025-0050791

(51) Int. Cl. G06F 9/46; G06F 9/48; G06F 9/50; G06F 9/54

(52) U.S. Cl. CPC G06F 9/461; G06F 9/4881; G06F 9/5027; G06F 9/542

(57) ABSTRACT

The present disclosure relates to an apparatus and method for processing radar signals. The radar signal processing apparatus according to one embodiment of the present disclosure includes a master processor and at least one slave processor. The master processor performs a main task for signal processing and sets a trigger for allowing the at least one slave processor to perform an event task. The slave processor, which is called by the trigger, notifies the master processor of the completion of the event task through an interrupt service routine (ISR) when the event task is completed. Accordingly, complex tasks can be effectively managed by a finite state machine (FSM) technique, and system resources can be utilized more efficiently.

### CROSS-REFERENCE TO RELATED APPLICATION

The present application claims priority under 35 U.S.C. § 119(a) to Korean patent application number 10-2025-0050791 filed on Apr. 18, 2025, in the Korean Intellectual Property Office, the entire disclosure of which is incorporated by reference herein.

### BACKGROUND

### Technical Field

The present disclosure relates to sensor signal processing technology, and more particularly, to a technology for optimizing a software architecture for radar sensor signal processing.

### Description of Related Art

As driver assistance devices and systems such as autonomous driving and Advanced Driver Assistance Systems (ADAS) continue to evolve, the importance of sensors used therein—such as cameras, radars, and lidars—is also increasing.

As the types and number of sensors increase, the signal processing systems for processing signals from these sensors inevitably become more complex. In addition, as multiple core architectures have become common in vehicle electronic apparatus control systems, it has become necessary to manage the priorities of various signal processing operations and tasks.

However, in the related art, sensor signal processing has been performed simply in a sequential manner according to the required functions, and thus, lower-priority tasks are delayed in their call timing, resulting in an increased cycle time.

In addition, when a core operating as a master requests a task to a core operating as a slave, time is consumed while waiting for the result of the requested task. Even when there is no dependency between input and output data, the structure is configured to wait until the previous step is completed, which leads to a problem of poor overall software performance.

The inventors of the present disclosure have made extensive research efforts to solve the above-described problems of radar signal processing in the related art. After considerable effort, the inventors have completed the present disclosure, which provides a radar signal processing apparatus and method capable of adjusting task priorities among multiple cores, immediately delivering task results to a master core, and enabling parallel operations among the multiple cores.

### BRIEF SUMMARY

The present disclosure is directed to providing a signal processing apparatus and method capable of improving overall system efficiency by effectively distributing resources among cores in a multiple core system.

The present disclosure is also directed to providing a signal processing apparatus and method capable of reducing computation time and memory usage by adjusting the priority of tasks for each core and enabling parallel processing of multiple cores according to task types.

Meanwhile, other aspects not specified of the present disclosure will be additionally contemplated within the range that can be easily inferred from the following detailed description and effects thereof.

A signal processing apparatus according to the present disclosure comprises a memory comprising one or more instructions; and a plurality of processors configured to execute the one or more instructions stored in the memory, wherein the plurality of processors comprise a master processor and one or more slave processors, the master processor is configured to perform a main task for signal processing and set a trigger to allow the one or more slave processors to perform an event task, and when the slave processor called by the trigger completes execution of the event task, the slave processor is configured to notify the master processor of the completion of the event task through an interrupt service routine (ISR).

The signal to be processed may be a radar sensor signal.

The master processor may be configured to perform the main task at predetermined time intervals.

The slave processor may be configured to perform the event task by a finite state machine (FSM) method.

The FSM may include only one termination state caused by an error.

The master processor, after calling the event task, may be capable of calling, without waiting for the completion of the event task, a new event task.

The main task or the event task may be controlled by a single interrupt.

When a busy-wait state occurs in which the main task or the event task waits for processing of another task, the busy-wait state may be treated as an error, and the task may be halted.

The master processor may be configured to access the one or more slave processors only through the event task.

An operating system (OS) for controlling the plurality of processors may be an AUTOSAR (AUTomotive Open System ARchitecture) OS.

In a sensor signal processing method performed by a signal processing apparatus comprising a plurality of processors and a memory, according to the present disclosure, the plurality of processors comprise a master processor and one or more slave processors, and the method comprise performing, by the master processor, a main task for signal processing; setting, by the master processor, a trigger to allow the one or more slave processors to perform an event task; performing, by the one or more slave processors, the event task; and notifying, by the one or more slave processors, the master processor of completion of the event task through an interrupt service routine (ISR) when the one or more slave processors complete execution of the event task.

The signal to be processed may be a radar sensor signal.

The master processor may be configured to perform the main task at predetermined time intervals.

The slave processor may be configured to perform the event task by a finite state machine (FSM) method.

The FSM may include only one termination state caused by an error.

The master processor, after calling the event task, may be capable of calling, without waiting for the completion of the event task, a new event task.

The main task or the event task may be controlled by a single interrupt.

When a busy-wait state occurs in which the main task or the event task waits for processing of another task, the busy-wait state may be treated as an error, and the task may be halted.

The master processor may be configured to access the one or more slave processors only through the event task.

An operating system (OS) for controlling the plurality of processors may be an AUTOSAR OS.

According to the present disclosure, there is an effect of optimizing the efficiency of a multiple core-based system for radar signal processing.

In addition, by optimizing parallel processing and interrupt handling among multiple cores, the time required for task execution can be reduced.

Furthermore, by applying a finite state machine (FSM) technique to optimize complex tasks and utilizing context information, intuitive and concurrent debugging can be achieved in abnormal operation situations.

In the meantime, even if there is an effect not explicitly specified herein, it is added that the effects expected by the technical features of the present disclosure and described effects and provisional effects thereof in the following specification are regarded as described in the specification of the present disclosure.

### BRIEF DESCRIPTION OF THE SEVERAL VIEWS OF THE DRAWINGS

FIG. 1 is a schematic diagram illustrating a configuration of a signal processing apparatus according to an exemplary embodiment of the present disclosure.

FIG. 2 is a detailed diagram illustrating a processor of the signal processing apparatus according to an exemplary embodiment of the present disclosure.

FIG. 3 is a schematic flow diagram illustrating task execution between processors according to an exemplary embodiment of the present disclosure.

FIG. 4 illustrates an example of a finite state machine (FSM) according to an exemplary embodiment of the present disclosure.

FIGS. 5 - 8 are schematic flowcharts illustrating tasks performed in the signal processing apparatus according to an exemplary embodiment of the present disclosure.

FIG. 9 is a schematic flowchart illustrating a signal processing method according to another exemplary embodiment of the present disclosure.

FIG. 10 is a diagram for describing a computing environment including a computing apparatus according to another exemplary embodiment of the present disclosure.

The accompanying drawings are provided for reference to aid in understanding the technical spirit of the present disclosure, and the scope of the present disclosure is not limited thereto.

### DETAILED DESCRIPTION

Hereinafter, specific embodiments according to exemplary embodiments of the present disclosure will be described with reference to the accompanying drawings. The following detailed description is provided to aid in a comprehensive understanding of the methods, apparatuses, and/or systems described herein. However, these are merely examples, and the present disclosure is not limited thereto.

In describing the exemplary embodiments of the present disclosure, detailed descriptions of well-known technologies related to the present disclosure will be omitted when it is determined that such descriptions may unnecessarily obscure the essence of the embodiments. The terms described below are defined in consideration of the functions of the present disclosure and may vary depending on the intention or custom of the user or operator, or other practices. Therefore, the definitions of the terms should be interpreted based on the overall contents of this specification. The terminology used in the detailed description is merely intended to describe exemplary embodiments and should not be interpreted as limiting. Unless clearly stated otherwise, expressions in the singular form include the plural form as well. In this description, expressions such as "comprise," "include," or "provide" are intended to indicate the presence or possibility of one or more characteristics, numbers, steps, operations, or elements, or combinations thereof, and should not be construed as excluding the presence or possibility of one or more other characteristics, numbers, steps, operations, or elements, or combinations thereof. In addition, terms such as “unit,” “device,” “means,” “part,” “member,” “module,” “block.” etc., which are described in the specification, mean a unit of a comprehensive configuration that performs at least one function or operation, which may be implemented in hardware or software, or in a combination of hardware and software.

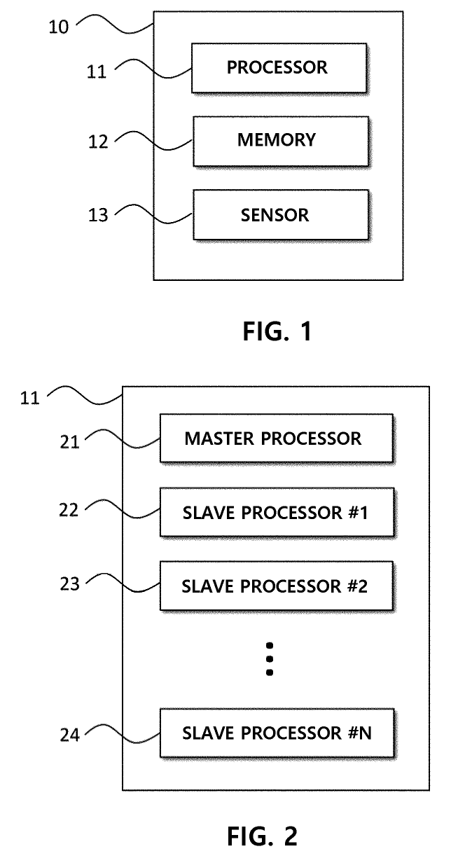

FIG. 1 is a schematic diagram illustrating a configuration of a radar signal processing apparatus according to an exemplary embodiment of the present disclosure.

The signal processing apparatus 10 according to the present disclosure may include at least one processor 11 and a memory 12.

The memory 12 may store instructions, data structures, and program code that can be read by the processor 11. In the exemplary embodiments, at least the operations performed by the processor 11 may be implemented by executing the instructions or code of a program stored in the memory 12.

The memory 12 may include a flash memory type, a hard disk type, a multimedia card micro type, or a card-type memory (e.g., SD or XD memory), and may include non-volatile memory including at least one of a read-only memory (ROM), an electrically erasable programmable read-only memory (EEPROM), a programmable read-only memory (PROM), a magnetic memory, a magnetic disk, or an optical disk, and volatile memory such as a random access memory (RAM) or a static random access memory (SRAM).

The memory 12 may store one or more instructions or programs that can be used by the signal processing apparatus 10 to process signals received from sensors such as a lidar sensor or a radar sensor, depending on the situation.

The processor 11 controls overall operations of the signal processing apparatus 10. For example, the processor 11 may control overall operations of the signal processing apparatus 10 for processing signals by executing one or more instructions stored in the memory 12.

The processor 11 may include, for example, at least one of a central processing unit (CPU), a microprocessor, a graphics processing unit (GPU), an application-specific integrated circuit (ASIC), a digital signal processor (DSP), a digital signal processing device (DSPD), a programmable logic device (PLD), a field programmable gate array (FPGA), an application processor, a neural processing unit (NPU), or a processor dedicated to artificial intelligence designed with a hardware architecture specialized for processing AI models, but is not limited thereto.

The sensor 13 is used to acquire environmental information in front of or around a vehicle.

For this purpose, the sensor 13 may include a lidar sensor, a radar sensor, a camera sensor, or the like, but is not limited thereto.

The lidar sensor emits millions of laser pulses per second and analyzes the reflected light to generate an image.

Since the lidar sensor uses laser light with strong straight-line propagation characteristics and a short wavelength, it provides higher precision compared to sensors such as radars that use radio waves.

Unlike the lidar sensor that uses light (laser), the radar sensor detects the distance, direction, and speed of an object using electromagnetic waves.

Although the radar sensor is less precise than the lidar sensor, it has the advantage of being less affected by environmental factors such as snow, rain, fog, and dust.

The camera sensor is used to acquire environmental information around the vehicle based on light reflected from objects. The camera sensor may be a visible light camera sensor or an infrared camera sensor.

Hereinafter, the signal processing apparatus 10 according to the present disclosure will be described as processing radar sensor signals; however, it is to be understood that the present disclosure may also be applied to the processing of other sensor signals.

FIG. 2 is a detailed diagram illustrating a processor of the signal processing apparatus according to an exemplary embodiment of the present disclosure.

The processor 11 may include a plurality of cores (processors), and may include a master processor 21 and one or more slave processors 22, 23, …, 24.

The master processor 21 manages an overall process of receiving signals from the sensor 13 and processing the signals, and controls tasks of the slave processors 22, 23, …, 24.

The processor 11 according to the present disclosure may be configured as a system on chip (SoC) for radar signal processing. The master processor 21 may have an M7 core, and each of the slave processors 22, 23, …, 24 may have one core of A53, SPT, or BBE32; however, the present disclosure is not limited thereto.

The slave processors 22, 23, …, 24 receive tasks assigned from the master processor 21, perform the corresponding tasks, and return the results.

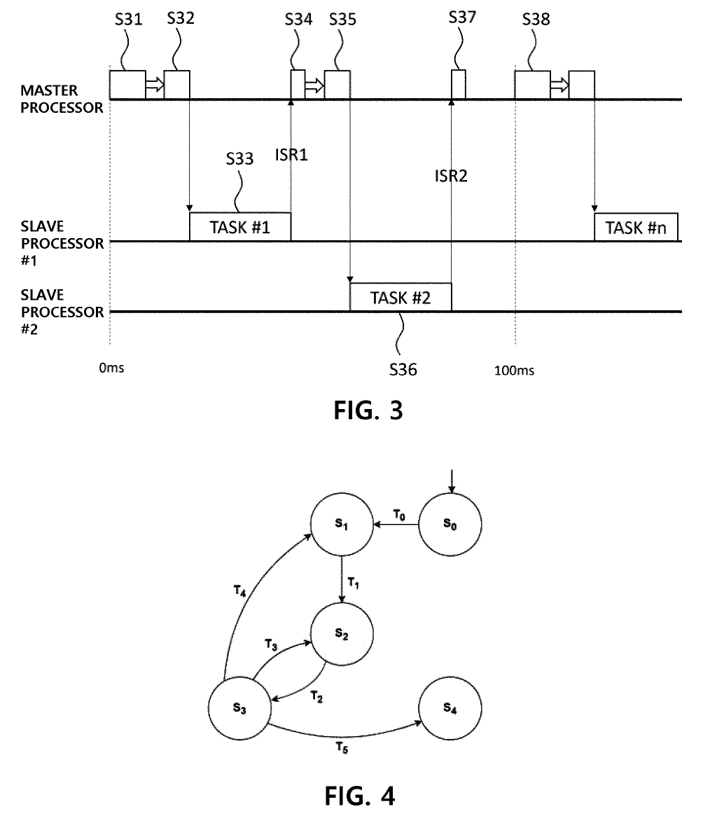

FIG. 3 is a schematic flow diagram illustrating task execution between processors according to an exemplary embodiment of the present disclosure.

The master processor 21 monitors the states of all the slave processors 22, 23, …, 24 and processes an operation sequence.

A main task (S31) is a task that is called at predetermined intervals by an operating system (OS).

The main task (S31) may be called every 100 ms; however, the present disclosure is not limited thereto and the interval may vary depending on the operating system or application program.

The operating system may be an automotive operating system such as EB AUTOSAR OS, but is not limited thereto.

The main task (S31) has a low priority and is therefore executed in the master processor 21 with high latency.

The main task (S31) is performed to check whether the slave processors such as REF, SPT, and BBE32 are initialized. If they are not initialized, an initialization routine (RSP_Init) is executed, and if they are initialized, a trigger S32 for an event task is executed.

The main task (S31) includes one execution function and an event trigger, and it must not directly access the slave processors but may access them by triggering the event task.

An event task (S32) called from the main task S31 is a task having the second-highest priority and is performed by the slave processors 22, 23, …, 24.

For example, when the master processor 21 calls a first event task (S32) to be performed by a first slave processor 22, the first slave processor 22 performs the first event task (S33) and returns the result to the master processor 21.

The master processor 21 does not wait after calling the first slave processor 22 to perform the first event task (S33). Accordingly, the master processor 21 may simultaneously call the second slave processor 23 or another slave processor 24 to perform another event task.

When the first slave processor 22 completes the execution of the first event task (S33), it generates an interrupt (S34) to notify the master processor 21 of the completion of the first event task (S33). When the interrupt occurs, a callback function is automatically called.

An arbitrator (Arbitrator) API function exists for callback processing.

The callback arbitrator API is used to manage the process of event tasks, and this function should be called immediately after the ISR callback occurs.

All event types, except for “RFE_CB” and “A53_PERSIST_CMD,” use the same routine and conditions to proceed to the next process.

To prevent preemption during postprocessing by the ISR callback, a lock of the master processor should be checked by the arbitrator API.

The arbitrator API function should be executed only in the ISR context and should not operate in a conditional loop or blocking mode.

The callback occurrence count should always be less than or equal to the callback request count. At this time, only when the callback occurrence count is equal to the callback request count can it be considered that all requested callback tasks have proceeded to the postprocessing stage.

An event task may call the arbitrator API function, but it should be called only when preemption of postprocessing occurs.

The arbitrator API function is used to manage the serialization of event tasks according to each event type.

The event types may include immediate or persistent commands of SPT, BBE32, and A53.

A response callback for a persistent command of A53 should not be set because it may cause unnecessary flags.

The callback context should not generate loop-condition code, and all callback functions should call the arbitrator API function to proceed through an interrupt.

A second flag is used to check whether the master processor is locked, in order to prevent the interrupt service routine (ISR) from entering a deadlock state.

An inter-processor communication (IPC) API request should be used for IPC requests for all slave processors.

The IPC request function checks the status of an event task when the event task sends an IPC command and checks the event type that issued the command. This function processes only predetermined event types.

This function may create a busy-wait state; however, if a busy-wait state occurs, the event task treats it as an error and transitions to a suspended state. Accordingly, the event task prevents a busy-wait state for all processes.

The event task is used for all signal processing logic and sequencing that include control of all slave processors.

The event task has one executable function and an EB event trigger.

The event task has the second-highest priority, except in exceptional cases, such as a 1-ms task.

When the event task is performed by the slave processors 22, 23, …, 24, it may be executed within a finite state machine (FSM).

The event task may be performed for limited inputs, events, and transitions, which is intended to enhance the robustness of the software.

FIG. 4 illustrates an example of a finite state machine (FSM) according to an exemplary embodiment of the present disclosure.

The FSM model according to the present disclosure includes five states, six events, and six transitions.

The FSM model according to the present disclosure may be based on a Mealy model, but is not limited thereto. In addition, it may operate as a deterministic finite automaton (DFA), but is not limited thereto.

The FSM model includes five states (S₀ to S₄).

The S₀ state is an initialization (INIT) state for initializing an event task that prepares data and task states of the master processor 21.

The S₁ state is a ready (READY) state, which represents a waiting state before the main task of the master processor 21 scans sensor signals.

In this state, no task is performed, and the FSM remains idle until an event (E₀) occurs to cause a transition to the next state.

The S₂ state is a running (RUNNING) state in which a sequential signal processing logic sequence is executed.

This state is invoked according to a predetermined process sequence table, and each process operates according to the same processing routine.

An operation route is selected by checking internal state flags and values, and most checkpoints in this state verify inputs and conditions that are not accepted.

The S₃ state is a waiting (WAIT) state, in which the overall process has not yet been completed and is waiting for the next process.

In this state, no task is performed, and the FSM remains idle until a transition event (E₁ or E₂) occurs to cause a transition to the next state.

The S₄ state is a halt (HALT) state, in which all event tasks are stopped under predetermined conditions or situations.

If any error occurs in the overall operation or a related process, a transition to this state occurs, and the FSM remains in an infinite loop in this state.

For transitions between these states, the FSM model includes three events (E₀to E₃).

The E₀ event is a main task trigger (MAIN_TASK_TRIGGER) event, which is triggered by the main task that occurs at predetermined time intervals.

As shown in the example of FIG. 3, the main task may be set to occur every 100 ms, and the E₀ event is triggered therein.

The E₁ event is an event task trigger (EVENT_TASK_TRIGGER) event, which occurs when the process of each task is completed.

The E₁ event occurs in the S₃ state according to conditions C₁ and C₂, which will be described later.

The E₂ event is an event task callback trigger (EVENT_TASK_CALLBACK_TRIGGER) event, which occurs at the end of the callback routine of each slave processor 22, 23, …, 24. In the case of the A53 core, a response to a persistent command is expected.

The FSM model includes six conditions (C₀ to C₅) as conditions for state transitions.

The C₀ condition is an initialization condition that is checked whenever an event task is called. If the C₀ condition is not set, initialization has not been performed, so initialization is executed; and if the C₀ condition is set, initialization has already been performed previously, so initialization is skipped and the process proceeds to the next process.

Accordingly, the C₀ condition is set immediately before the completion of the initialization process of the event task.

The C₁ and C₂ conditions are conditions for determining whether the process context of the event task has been executed and are checked at the end of the process chain.

In the S₃ state, these conditions determine whether a T₃ or T₄ transition occurs. When the C₁ condition is satisfied, the T₄ transition occurs and the FSM transitions to the S₁state; when the C₂condition is satisfied, the T₃transition occurs and the FSM transitions to the S₂ state.

The C₃ condition is a task process completion condition that determines whether to perform the T₂ transition.

The C₃ condition is set during postprocessing of the event task context.

The C₄condition is a callback process completion condition that determines whether to perform the T₂transition.

The C₄ condition is set by comparing the required callback count with the received callback count in the postprocessing context.

Finally, the C₅ condition is an error flag condition that is checked before the E₁ event is set in the final process of the event task context. If it is set in the interrupt service routine (ISR) context, it is ignored.

Since the C₅ condition is used to check for errors, it may be checked at critical points in the operation of the event task. This condition should be controlled only by the API function definition, and an ignorable flag may be set.

The FSM model includes six state transitions (T₀ to T₅).

The T₀ transition is a transition from the S₀state to the S₁ state, which occurs when the E₀ event and the C₀ condition are satisfied.

That is, when the initialization process is completed in the S₀ state and the main task trigger occurs, a transition to the S₁ state is performed.

The T₁transition is a transition from the S₁ state to the S₂ state, which occurs when the E₀ event and the C₀ condition are satisfied.

That is, when the initialization process is completed in the S₁ state and the main task trigger occurs, a transition to the S₁ state is performed. If the initialization process is not completed or the main task trigger does not occur, the S₁ state is maintained.

The T₂ transition is a transition from the S₂ state to the S₃ state, which occurs when the C₃ condition and the C₄condition are satisfied.

As described above, the C₃ condition is set during postprocessing of the event task, and the C₄ condition is determined by comparing callback counts in the postprocessing context.

The C₄ condition is set when the E₂ event occurs, but it may also be set when the required callback count is 0 even if the E₂ event does not occur.

The T₃ transition is a transition from the S₃state to the S₂state, which occurs when the E₁ event and the C₂ condition are satisfied.

That is, when the process completion event (E₁) occurs under the condition (C₂) in which the context of the event task process has not been completed, a transition to the S₂ state is performed, and thus the context of the event task process is executed.

The T₄ transition is a transition from the S₃ state to the S₁ state, which occurs when the E₁event and the C₁ condition are satisfied.

That is, unlike the T₃transition, when the process completion event (E₁) occurs under the condition (C₁) in which the context of the event task process has been completed, a transition to the S₁ state is performed, and thus the FSM waits for the execution of a new context of the event task.

Finally, the T₅ transition is a transition from the S₃ state to the S₄state, which occurs when the C₅ condition is satisfied.

That is, when an error occurs under the condition (C₅), a transition to the S₄ state, in which the FSM remains in an infinite waiting state, is performed.

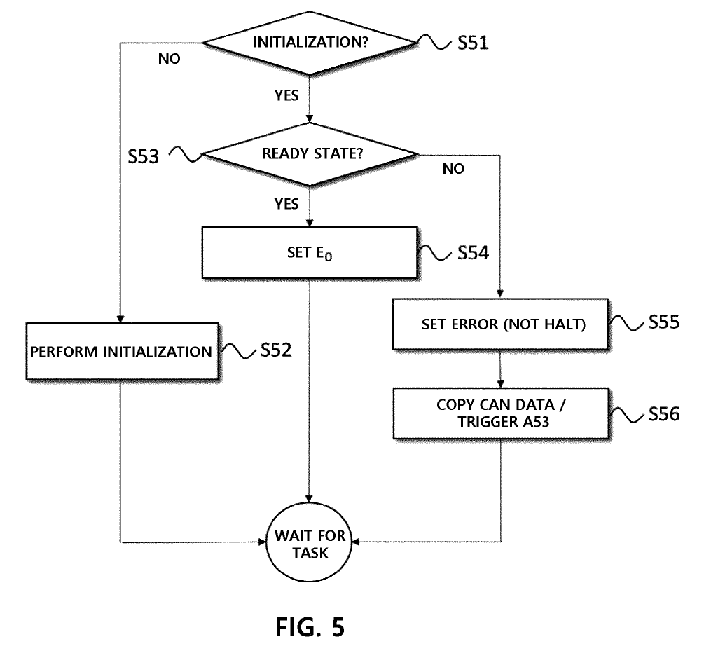

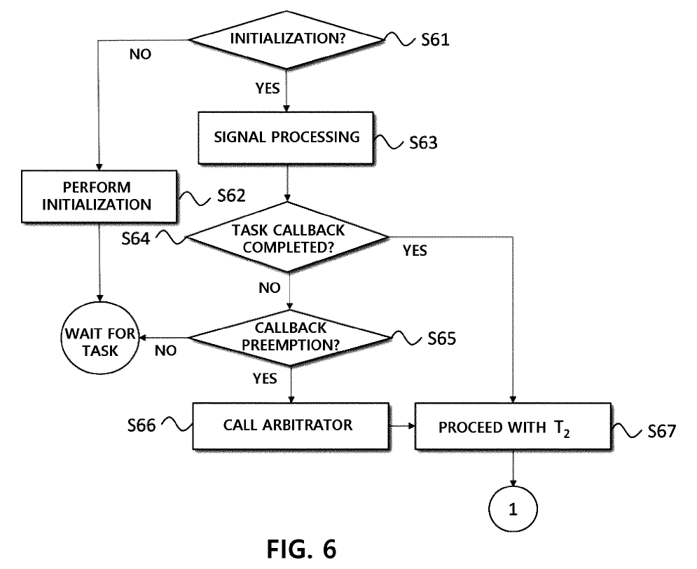

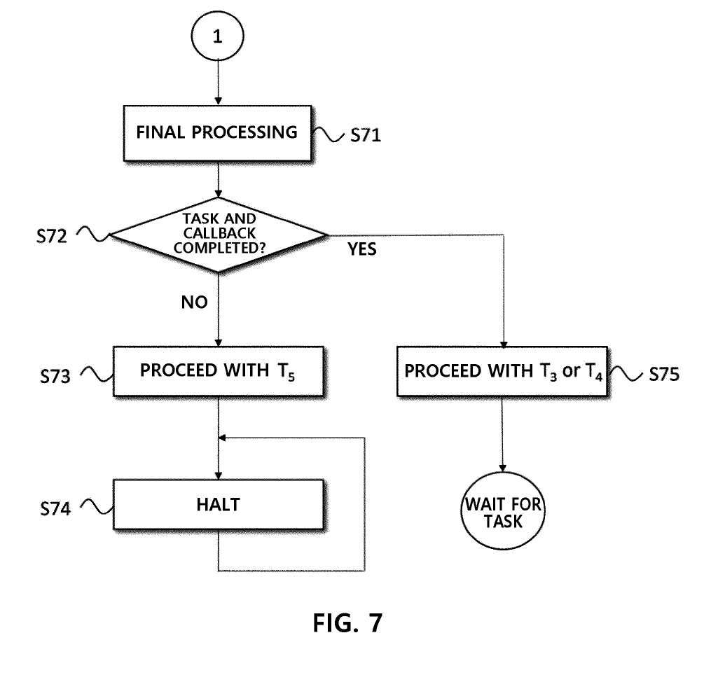

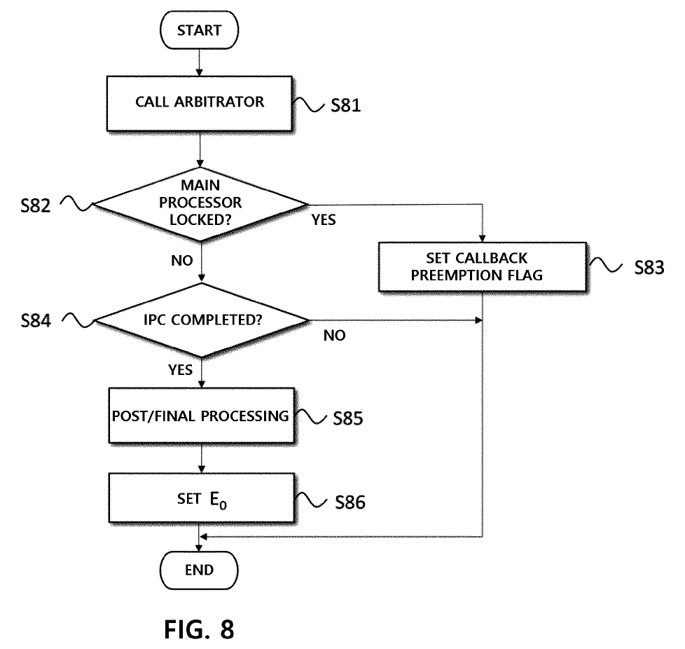

FIGS. 5 - 8 are schematic flowcharts illustrating tasks performed in the signal processing apparatus according to an exemplary embodiment of the present disclosure.

FIG. 5 is a schematic flowchart of a main task according to the present disclosure.

The main task, which is called at predetermined time intervals in the master processor 21, first checks whether initialization has been performed (S51).

If initialization has not been performed, initialization (RSP_Init) is executed (S52), after which the main task is terminated and enters a waiting state.

If initialization has been completed, it is checked whether the event task is in a ready (READY) state (S53).

If the event task is in the ready state, an E₀event is set to trigger the event task (S54).

If the event task is not yet in the ready state, it is set to an ERROR state (S55), after which the vehicle CAN (Control Area Network) is copied and a trigger of the slave processor (A53) is set (S56).

At this time, even if the ERROR state is set, the FSM is not halted (HALT); instead, the main task is terminated and returns to the task waiting state.

FIGS. 6 and 7 are schematic flowcharts of event tasks according to the present disclosure.

When the event task is called by any of the E₀, E₁, or E₂ events, it is first checked whether the event task has been initialized (S61).

The execution of the event task is triggered by an event task trigger and should be called only in the main task or the final processing (finalizeProcess) of the event task performed by the master process. This can be called only through the ‘setTrigger’ API of the event task.

The execution of the event task includes only a main process (procMain) or a process initialization (proc_init) sequence.

When an event task trigger request is made, the event task trigger first checks the state of the event task. The ‘setTrigger’ function must be called with an exact event type in order to distinguish the caller.

When the main task (RSP_Main) calls, the event task must not be triggered if the state of the event task is not in the ‘READY’ state or the ‘NOT_INIT’ state.

When the event task (RSP_Event) or a callback other than an A53 persistent command calls, the event task must not be triggered if the state of the event task is in the ‘READY’ state.

In the case of a trigger by an A53 persistent command, it can be called in the next cycle only when the cycle of the master processor 21 has been completed.

If initialization has not been performed, an initialization process for the event task is executed (S62), which corresponds to the S₀ state of the FSM.

After initialization is completed, a T₁ transition occurs, and the state is switched to a task waiting state corresponding to the S₁ state of the FSM.

If initialization has been completed, signal processing processes are performed (S63).

The state in which signal processing processes are performed corresponds to the S₂ state of the FSM.

The signal processing processes may include main processing (procMain), preprocessing (preProcess), core processing (doProcess), postprocessing (postProcess), and final processing (finalizeProcess), but are not limited thereto.

In the signal processing process, full-scale processes for radar signal processing may be performed.

When the signal processing task is completed, it is checked whether both the event task and the callback have been completed (S64).

If both the event task and the callback have been completed, a T₂ transition occurs (S67), and the state transitions to the next step for process finalization, that is, to the S₃state.

If both the event task and the callback have not been completed, it is checked whether callback preemption has occurred (S65).

If callback preemption has not occurred, the event task is completed and transitions to the task waiting state.

On the other hand, if callback preemption has occurred, the arbitrator callback (callbackArbitrator) and postprocessing are executed (S66), and a T₂ transition occurs (S67), causing the state to transition to the next step for process finalization, that is, to the S₃ state.

In FIG. 7, after the transition to the S₃ state, final processing (finalizeProcess) is performed (S71), and it is checked again whether both the task and the callback have been completed (S72).

If both the event task and the callback have been completed, an E₁ event is set, and a T₃ transition or a T₄ transition occurs (S75), switching to the task waiting state.

However, if either the event task or the callback has not been completed, a T₅ transition occurs (S73), the FSM state transitions to the S₄ state (S74), and the process is halted (HALT), remaining in an infinite loop and waiting state.

FIG. 8 is a schematic flowchart of a callback function by an interrupt according to the present disclosure.

When an interrupt is called by the slave processors 22, 23, …, 24, the callback function is invoked in the interrupt service routine.

First, a callback arbitrator function (callbackArbitrator) is called (S81), and it is checked whether the master processor 21 is in a locked state (S82).

If the master processor is locked, a callback preemption flag is set, and the interrupt service is terminated (S83).

If the master processor is not locked, it is checked whether all inter-processor communication (IPC) operations have been completed (S84).

If all IPC operations have been completed, postprocessing and final processing are performed (S85), and an E₂ event is set to terminate the interrupt service (S86).

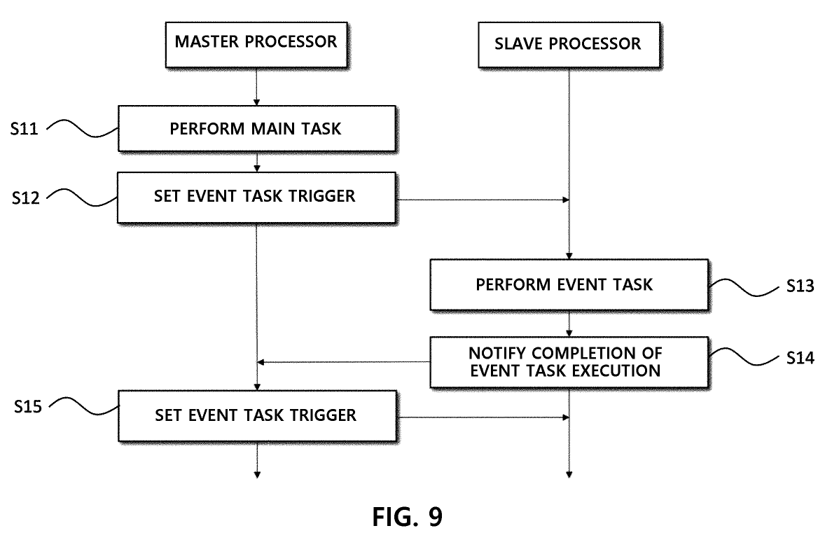

FIG. 9 is a schematic flowchart illustrating a signal processing method according to another exemplary embodiment of the present disclosure.

The signal processing method according to the present disclosure may be performed by a signal processing apparatus including a plurality of processors and a memory.

A master processor manages an overall process for receiving and processing signals from a sensor and monitors and manages the tasks of slave processors.

Each slave processor is assigned a task for sensor signal processing from the master processor, performs the corresponding task, and returns the result.

The master processor performs a main task (S11).

The main task is a task that is called at predetermined time intervals by an operating system, for example, every 100 ms, but is not limited thereto.

In addition, the operating system may be an automotive operating system such as EB AUTOSAR OS, but is not limited thereto.

In the main task, initialization for signal processing is performed, and an event task to be processed by a slave processor for signal processing is triggered (S12).

The main task performed by the master processor includes only one execution function and an event trigger, and the slave processor cannot be directly accessed but can be accessed only through the event task.

A slave processor performs an event task assigned by the event task trigger of the master processor (S13).

The event task includes full-scale processes for signal processing and processes signals received from a radar sensor. The sensor signals processed according to the present disclosure are not limited to radar sensor signals and may be applied to all types of sensor signals, such as lidar sensor signals or camera sensor signals.

For effective execution of the event task, the event task may be performed by an FSM method, and as described above, the FSM includes only one termination state caused by an error.

When the execution of the event task by the slave processor is completed, the completion of the event task execution is delivered to the master processor through an interrupt service routine (ISR) (S14).

Since the master processor can immediately recognize the completion of the event task through the ISR, it does not need to wait until the event task is completed in the slave processor, and it is possible to trigger a new event task in another slave processor.

Accordingly, event tasks that are unrelated to each other can be triggered to be performed in parallel by different slave processors, thereby allowing processor resources to be used more efficiently.

When the completion of the event task execution is delivered through the interrupt service routine (ISR), the master processor can set a trigger for a new event task (S15).

As described above, since the main task and the event task are controlled by a single interrupt, there is an advantage of efficiently using limited system resources.

In addition, since the main task and the event task treat a busy-wait state as an error, unnecessary waiting states can be prevented.

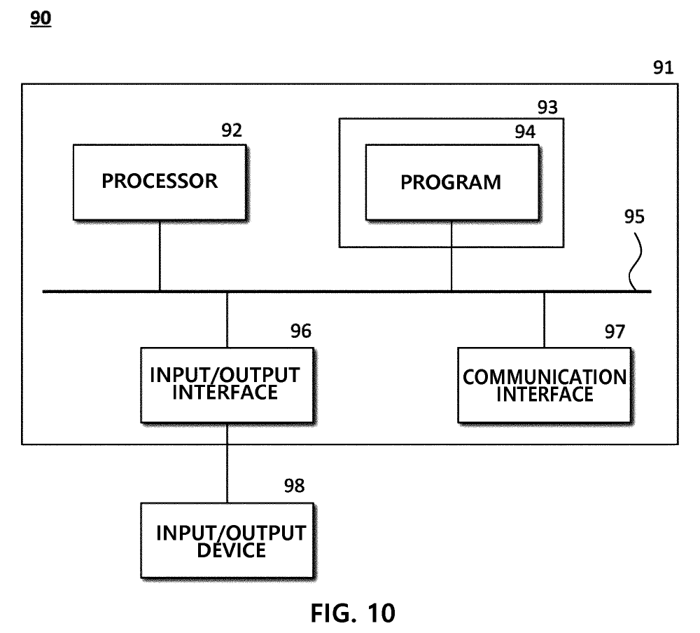

FIG. 10 is a diagram for describing a computing environment including a computing apparatus according to another exemplary embodiment of the present disclosure.

In the illustrated embodiment, each component may have functions and capabilities different from those described below, and additional components not described below may also be included. The illustrated computing environment 90 includes a computing apparatus 91, which can perform the signal processing method illustrated in FIG. 9. In one embodiment, the computing apparatus 91 may include one or more components included in the signal processing apparatus illustrated in FIG. 1.

The computing apparatus 91 includes at least one processor 92, a computer-readable storage medium 93, and a communication bus 95. The processor 92 may cause the computing apparatus 91 to operate according to the exemplary embodiments described above. For example, the processor 92 may execute one or more programs 94 stored in the computer-readable storage medium 93. The one or more programs 94 may include one or more computer-executable instructions, and when executed by the processor 92, the computer-executable instructions may be configured to cause the computing apparatus 91 to perform operations according to the exemplary embodiments.

The communication bus 95 interconnects various other components of the computing apparatus 91, including the processor 92 and the computer-readable storage medium 93.

The computing apparatus 91 may also include one or more input/output (I/O) interfaces 96 that provide interfaces for one or more input/output devices 98, and one or more communication interfaces 97. The input/output interface 96 and the communication interface 97 are connected to the communication bus 95. The input/output device 98 may be connected to other components of the computing apparatus 91 via the input/output interface 96. Exemplary input/output devices 98 may include input devices such as pointing devices (e.g., a mouse or a trackpad), keyboards, touch input devices (e.g., a touchpad or a touchscreen), voice or sound input devices, various types of sensor devices, and/or image capturing devices, and output devices such as display devices, printers, speakers, and/or network cards. The exemplary input/output device 98 may be included inside the computing apparatus 91 as one component constituting the computing apparatus 91, or may be a separate device distinguished from the computing apparatus 91 and connected to the computing apparatus 91.

While the present disclosure has been described in detail with reference to representative embodiments, it will be understood by those skilled in the art that various modifications and equivalent other embodiments may be possible based on the present disclosure.

Accordingly, the true technical scope of the present disclosure should be defined by the spirit of the appended claims.

1. A signal processing apparatus, comprising:
a memory comprising one or more instructions; and
a plurality of processors configured to execute the one or more instructions stored in the memory,
wherein the plurality of processors comprise a master processor and one or more slave processors,
wherein the master processor is configured to perform a main task for signal processing and set a trigger to allow the one or more slave processors to perform an event task, and
wherein, when the slave processor called by the trigger completes execution of the event task, the slave processor is configured to notify the master processor of the completion of the event task through an interrupt service routine (ISR).

2. The signal processing apparatus of claim 1, wherein the signal to be processed is a radar sensor signal.

3. The signal processing apparatus of claim 1, wherein the master processor is configured to perform the main task at predetermined time intervals.

4. The signal processing apparatus of claim 1, wherein the slave processor is configured to perform the event task by a finite state machine (FSM) method.

5. The signal processing apparatus of claim 4, wherein the FSM includes only one termination state caused by an error.

6. The signal processing apparatus of claim 1, wherein the master processor, after calling the event task, is capable of calling, without waiting for the completion of the event task, a new event task.

7. The signal processing apparatus of claim 1, wherein the main task or the event task is controlled by a single interrupt.

8. The signal processing apparatus of claim 1, wherein, when a busy-wait state occurs in which the main task or the event task waits for processing of another task, the busy-wait state is treated as an error, and the task is halted.

9. The signal processing apparatus of claim 1, wherein the master processor is configured to access the one or more slave processors only through the event task.

10. The signal processing apparatus of claim 1, wherein an operating system (OS) for controlling the plurality of processors is an AUTOSAR (AUTomotive Open System ARchitecture) OS.

11. A signal processing method performed by a signal processing apparatus comprising a plurality of processors and a memory,
wherein the plurality of processors comprise a master processor and one or more slave processors, the method comprising:
performing, by the master processor, a main task for signal processing;
setting, by the master processor, a trigger to allow the one or more slave processors to perform an event task;
performing, by the one or more slave processors, the event task; and
notifying, by the one or more slave processors, the master processor of completion of the event task through an interrupt service routine (ISR) when the one or more slave processors complete execution of the event task.

12. The signal processing method of claim 11, wherein the signal to be processed is a radar sensor signal.

13. The signal processing method of claim 11, wherein the master processor is configured to perform the main task at predetermined time intervals.

14. The signal processing method of claim 11, wherein the slave processor is configured to perform the event task by a finite state machine (FSM) method.

15. The signal processing method of claim 14, wherein the FSM includes only one termination state caused by an error.

16. The signal processing method of claim 11, wherein the master processor, after calling the event task, is capable of calling, without waiting for the completion of the event task, a new event task.

17. The signal processing method of claim 11, wherein the main task or the event task is controlled by a single interrupt.

18. The signal processing method of claim 11, wherein, when a busy-wait state occurs in which the main task or the event task waits for processing of another task, the busy-wait state is treated as an error, and the task is halted.

19. The signal processing method of claim 11, wherein the master processor is configured to access the one or more slave processors only through the event task.

20. The signal processing method of claim 11, wherein an operating system (OS) for controlling the plurality of processors is an AUTOSAR OS.
